(19) United States
(12) Patent Application Publication
(10) Pub. No.: US 2013/0083706 A1
(43) Pub. Date: Apr. 4, 2013

(54) METHOD AND APPARATUS FOR IMPROVING TDD (TIME DIVISION DUPLEX) INTERBAND CARRIER AGGREGATION (CA) IN A WIRELESS COMMUNICATION SYSTEM

(71) Applicant: INNOVATIVE SONIC CORPORATION, Taipei City (TW)

(72) Inventor: Ko-Chiang Lin, Taipei City (TW)

(73) Assignee: INNOVATIVE SONIC CORPORATION, Taipei City (TW)

(21) Appl. No.: 13/627,274

(22) Filed: Sep. 26, 2012

Related U.S. Application Data
(60) Provisional application No. 61/539,202, filed on Sep. 26, 2011.

(51) Int. Cl. H04L 5/14

(52) U.S. Cl. CPC H04L 5/14
USPC 370/280

(57) ABSTRACT

A method and apparatus are disclosed to perform TDD interband carrier aggregation in a wireless communication system. The method includes aggregating cells with different TDD UL-DL (Uplink-Downlink) configurations, wherein the cells have different DL-to-UL (Downlink-to-Uplink) switch point periodicities. The method further includes determining conflict subframes according to dynamic scheduling.

### CROSS-REFERENCE TO RELATED APPLICATIONS

The present application claims the benefit of U.S. Provisional Patent Application Ser. No. 61/539,202 filed on Sep. 26, 2011, the entire disclosure of which is incorporated herein by reference.

### FIELD

This disclosure generally relates to wireless communication networks, and more particularly, to a method and apparatus for improving TDD (Time Division Duplex) interband carrier aggregation (CA) in a wireless communication system.

### BACKGROUND

With the rapid rise in demand for communication of large amounts of data to and from mobile communication devices, traditional mobile voice communication networks are evolving into networks that communicate with Internet. Protocol (IP) data packets. Such IP data packet communication can provide users of mobile communication devices with voice over IP, multimedia, multicast and on-demand communication services.

An exemplary network structure for which standardization is currently taking place is an Evolved Universal Terrestrial Radio Access Network (E-UTRAN). The E-UTRAN system can provide high data throughput in order to realize the above-noted voice over IP and multimedia services. The E-UTRAN system's standardization work is currently being performed by the 3GPP standards organization. Accordingly, changes to the current body of 3GPP standard are currently being submitted and considered to evolve and finalize the 3GPP standard.

### SUMMARY

A method and apparatus are disclosed to perform TDD interband carrier aggregation in a wireless communication system. The method includes aggregating cells with different TDD UL-DL (Uplink-Downlink) configurations, wherein the cells have different DL-to-UL (Downlink-to-Uplink) switch point periodicities. The method further includes determining conflict subframes according to dynamic scheduling.

### BRIEF DESCRIPTION OF THE DRAWINGS

FIG. 1 shows a diagram of a wireless communication system according to one exemplary embodiment.

FIG. 2 is a block diagram of a transmitter system (also known as access network) and a receiver system (also known as user equipment or UE) according to one exemplary embodiment.

FIG. 3 is a functional block diagram of a communication system according to one exemplary embodiment.

FIG. 4 is a functional block diagram of the program code of FIG. 3 according to one exemplary embodiment.

FIG. 5 is flowchart according to one exemplary embodiment.

FIG. 6 is flowchart according to one exemplary embodiment.

### DETAILED DESCRIPTION

The exemplary wireless communication systems and devices described below employ a wireless communication system, supporting a broadcast service. Wireless communication systems are widely deployed to provide various types of communication such as voice, data, and so on. These systems may be based on code division multiple access (CDMA), time division multiple access (TDMA), orthogonal frequency division multiple access (OFDMA), 3GPP LTE (Long. Term Evolution) wireless access, 3GPP LTE-A or LTE-Advanced (Long Term Evolution Advanced), 3PP2 UMB (Ultra Mobile Broadband), WiMax, or some other modulation techniques.

In particular, the exemplary wireless communication systems devices described below may be designed to support one or more standards such as the standard offered by a consortium named “3rd Generation Partnership Project” referred to herein as 3GPP, including Document Nos. 3GPP TS 36.213 V10.2.0, “E-UTRA Physical layer procedures (Release 10)”; R1-112106, “TDD Inter-band Carrier Aggregation”, CATT. The standards and documents listed above are hereby expressly incorporated herein.

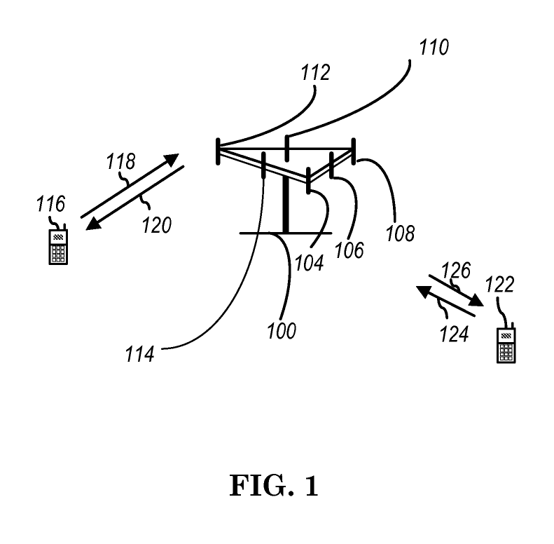

FIG. 1 shows a multiple access wireless communication system according to one embodiment of the invention. An access network 100 (AN) includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal 116 (AT) is in communication with antennas 112 and 114, where antennas 112 and 114 transmit information to access terminal 116 over forward link 120 and receive information from access terminal 116 over reverse link 118. Access terminal (AT) 122 is in communication with antennas 106 and 108, where antennas 106 and 108 transmit information to access terminal (AT) 122 over forward link 126 and receive information from access terminal (AT) 122 over reverse link 124. In a FDD system, communication links 118, 120, 124 and 126 may use different frequency for communication. For example, forward link 120 may use a different frequency then that used by reverse link 118.

Each group of antennas and/or the area in which they are designed to communicate is often referred to as a sector of the access network. In the embodiment, antenna groups each are designed to communicate to access terminals in a sector of the areas covered by access network 100.

In communication over forward links 120 and 126, the transmitting antennas of access network 100 may utilize beamforming in order to improve the signal-to-noise ratio of forward links for the different access terminals 116 and 122. Also, an access network using beamforming to transmit to access terminals scattered randomly through its coverage causes less interference to access terminals in neighboring cells than an access network transmitting through a single antenna to all its access terminals.

An access network (AN) may be a fixed station or base station used for communicating with the terminals and may also be referred to as an access point, a Node B, a base station, an enhanced base station, an eNodeB, or some other terminology. An access terminal (AT) may also be called user equipment (UE), a wireless communication device, terminal, access terminal or some other terminology.

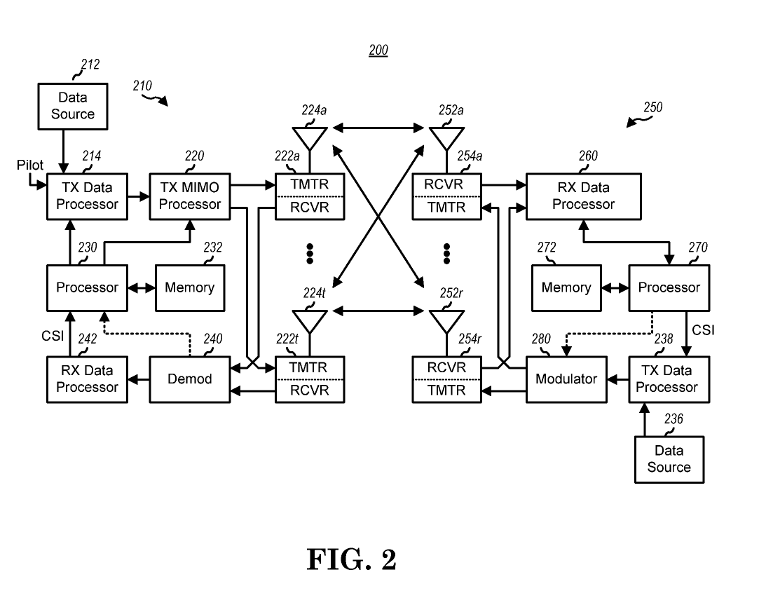

FIG. 2 is a simplified block diagram of an embodiment of a transmitter system 210 (also known as the access network) and a receiver system 250 (also known as access terminal (AT) or user equipment (UE)) in a MIMO system 200. At the transmitter system 210, traffic data for a number of data streams is provided from a data source 212 to a transmit (TX) data processor 214.

In one embodiment, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QPSK, M-PSK, or M-QAM) selected for that data stream to provide modulation symbols. The data rate, coding, and modulation for each data stream may be determined by instructions performed by processor 230.

The modulation symbols for all data streams are then provided to a TX MIMO processor 220, which may further process the modulation symbols (e.g., for OFDM), TX MIMO processor 220 then provides N_{T} modulation symbol streams to N_{T} transmitters (TMTR) 222a through 222t. In certain embodiments, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel, N_{T} modulated signals from transmitters 222a through 2221 are then transmitted from N_{T} antennas 224a through 2241, respectively.

At receiver system 250, the transmitted modulated signals are received by N_{R} antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the N received symbol streams from N_{R} receivers 254 based on a particular receiver processing technique to provide N_{T} “detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use (discussed below). Processor 270 formulates a reverse link message comprising a Matrix index portion and a rank value portion.

The reverse link message may comprise various types of information regarding the communication link and/or the received data stream. The reverse link, message is then processed by a TX data processor 238, which also receives traffic data thr a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights then processes the extracted message.

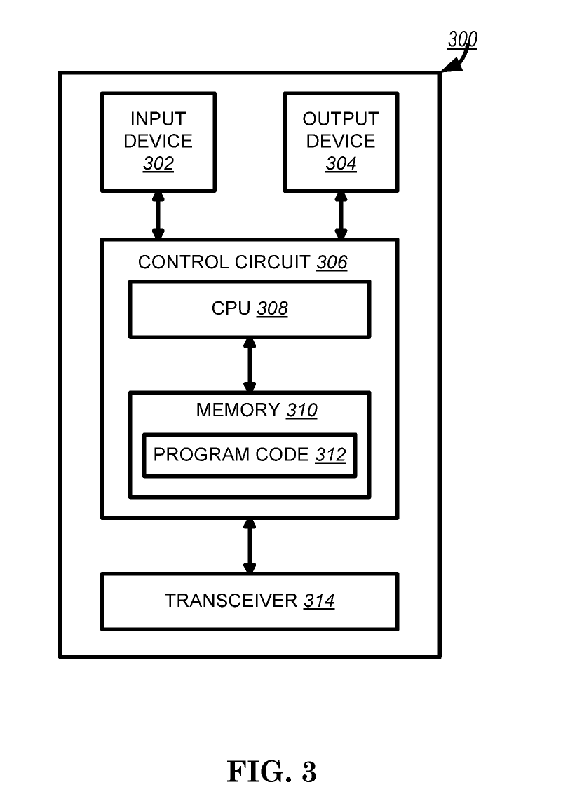

Turning to FIG. 3, this figure shows an alternative simplified functional block diagram of a communication device according to one embodiment of the invention. As shown in FIG. 3, the communication device 300 in a wireless communication system can be utilized for realizing the UEs (or ATS) 116 and 122 in FIG. 1, and the wireless communications system is preferably the LTE system. The communication device 300 may include an input device 302, an output device 304, a control circuit 306, a central processing unit (CPU) 308, a memory 310, a program code 312, and a transceiver 314. The control circuit 306 executes the program code 312 in the memory 310 through the CPU 308, thereby controlling an operation of the communications device 300. The communications device 300 can receive signals, input by a user through the input device 302, such as a keyboard or keypad, and can output images and sounds through the output device 304, such as a monitor or speakers. The transceiver 314 is used to receive and transmit wireless signals, delivering received signals to the control circuit 306, and outputting signals generated by the control circuit 306 wirelessly.

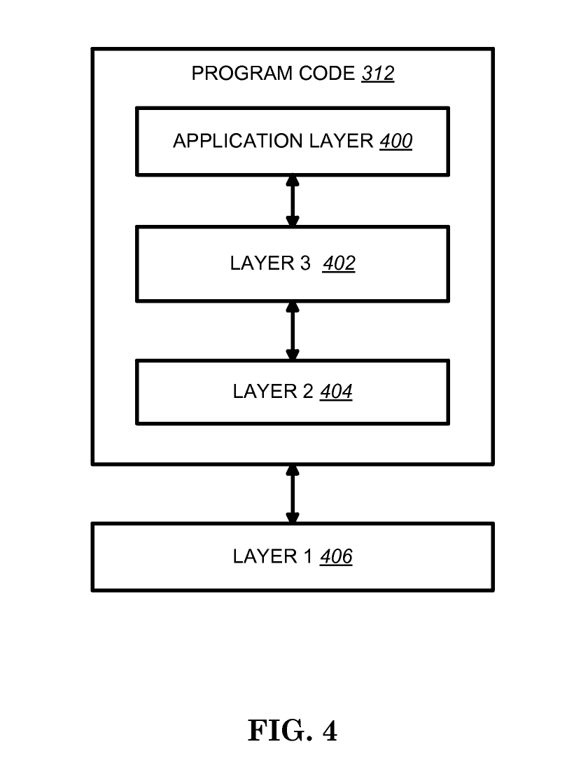

FIG. 4 is a simplified block diagram of the program code 312 shown in FIG. 3 in accordance with one embodiment of the invention. In this embodiment, the program code 312 includes an application layer 400, a Layer 3 portion 402, and a Layer 2 portion 404 and is coupled to a Layer 1 portion 406. The Layer 3 portion 402 generally performs, radio resource control. The Layer 2 portion 404 generally performs link control. The Layer 1 portion 406 generally performs physical connections.

In general, Carrier Aggregation (CA) is introduced to improve the data rate of UE by aggregating multiple cells for parallel transmission and reception, as discussed in 3GPP TS 36.213 V10.2.0. One topic for enhancement of CA is to allow different Time. Division Duplex (TDD) uplink (UL)-downlink (DL) configuration, for inter-band carrier aggregation, as discussed in R1-112106. The benefit is that the system can coexist with the current 3G network well and easier for deployment targeting for different need.

Because different TDD UL-DL configurations could be aggregated, it is possible that in some subframe(s) the subframe type is different. For example, in some cell, the subframe belongs to DL subframe while in other cell the subframe belongs to UL subframe, which could be considered as conflicting subframes. An interesting question is that whether a TDD UE supporting different UL-DL configuration is allowed to perform transmission (TX) and reception (RX) simultaneously. Regarding this issue, there are several alternatives (as shown in R1-112106) as follows:

Na simultaneous TX and RX

UL/DL type of conflict subframe is fixed, ex following Primary Cell (PCell)

UL/DL type of conflict subframe is changeable

configurable through RRC

dynamically changed through PDCCH

Simultaneous TX and RX

Conflict subframe can coexist as simultaneous TX and RX is supported.

For the case of no simultaneous TX and RX, one conflict subframe would be considered as either UL or DL and the above alternatives give different rules to make a decision. For example, in the case of following PCell (Primary Cell), the subframe would be considered the same UL/DL type as that of PCell. Also, in the case of configurable through RRC (Radio Resource Control), each subframe would indicated by RRC configuration as to whether it belongs to UL or DL. Furthermore, in the case of dynamically changed through PDCCH (Physical Downlink Control Channel), each subframe would dynamically determined by scheduling as to whether it belongs to UL or DL.

As discussed in R1-112106, there are currently seven different. TDD UL-DL configurations as shown in Table 1 below;

TABLE 1

| Uplink- | Downlink- | | | | | | | | | | |
|---|---|---|---|---|---|---|---|---|---|---|---|
| Downlink | to-Uplink | | | | | | | | | | |
| Con- | Switch-Point | Subframe Number | | | | | | | | | |
| figuration | periodicity | 0 | 1 | 2 | 3 | 4 | 5 | 6 | 7 | 8 | 9 |
| 0 | 5 ms | D | S | U | U | U | D | S | U | U | U |
| 1 | 5 ms | D | S | U | U | D | D | S | U | U | D |
| 2 | 5 ms | D | S | U | D | D | D | S | U | D | D |
| 3 | 10 ms | D | S | U | U | U | D | D | D | D | D |
| 4 | 10 ms | D | S | U | U | D | D | D | D | D | D |
| 5 | 10 ms | D | S | U | D | D | D | D | D | D | D |
| 6 | 5 ms | D | S | U | U | U | D | S | U | U | D |

UL transmission is typically prior to DL reception to allow eNB align the arrival time among the UEs to prevent interference and non-orthogonality to each other, as discussed in R1-112106. The timing difference is generally maintained by eNB and called timing advance (TA).

In general, for the case of carrier aggregation with different DL-to-UL switch point periodicity (for example, UL-DL configuration 1 and configuration 5), it would be possible that special subframe collide with DL subframe. For a special subframe in conflict is determined as DL subframe, the UL part of special subframe would be prohibited.

On the contrary, if special subframe is determined as the subframe type in conflict situation, the expected behavior for a cell in DL subframe would be listed and described below:

Assumption is UL/DL type of conflict subframe is fixed or configurable

No reception is allowed

This is the easiest way while obviously not efficient

Only PDCCH (Physical Downlink Control Channel) is allowed

Since the PDCCH only occupies the first two symbols, it will not affect the simultaneous RX/TX.

Allow partial PDSCH (Physical Downlink Shared Channel)
If the special subframe configuration allows PDSCH on some symbols, the DL subframe can apply special configuration of either cell (i.e., its own cell or dominant cell) so that some symbols of PDSCH is dropped and different TB (Transport Block) table is used.

Assumption is UL/DL type of conflict subframe is dynamically changed.
If there is no scheduling (ex. SRS) on the cell with special subframe, there is no UL transmission, so full subframe can be utilized for PDSCH reception
If there is scheduling (ex. SRS) on the cell with special subframe, there is no UL transmission, so only partial subframe can be utilized for PDSCH reception.

However, if the SRS is triggered through PDCCH and the PDCCH is mis-detected, eNB assumes partial subframe is utilized for PDSCH while UE assumes full subframe is utilized for PDSCH and the decoding will fail. It is also possible for LIE to try to decode both type of PDSCH (i.e., one assuming full subframe and the other assuming partial subframe). Nevertheless the complexity is high and more memory is occupied, and even exponentially increases as the number of retransmission increases.

One solution, is to implement a restriction that a cell with different DL-to-UL switch point periodicity cannot be aggregated together. Another option is that the seventh subframe is either a DL subframe or a special subframe by a predefined rule (such as fixed or varied depending on configuration), while for other subframes, the determination of subframe type of conflict subframe would be dynamically changed through PDCCH. Another possibility is that for the cell in which the subframe type of the seventh subframe is DL, the PDSCH in the subframe would use only part of the subframe irrespective of the scheduling.

In addition, the combination (shown in Table 2 below) is considered as an example:

TABLE 2

| | Subframe Number | | | | | | | | | |
|---|---|---|---|---|---|---|---|---|---|---|
| | 0 | 1 | 2 | 3 | 4 | 5 | 6 | 7 | 8 | 9 |
| Cell 1 | D | S | U | U | D | D | S | U | U | D |
| Cell 2 | D | S | U | D | D | D | D | D | D | D |
| Determination of the | | | | U | | | D | D | U | |
| conflict subframes | | | | | | | | | | |

For the eighth subframe, the subframe is determined as a downlink subframe. However, the uplink subframe below the eighth subframe might collide with it as the transmission of the UL would take place earlier. Moreover, if the determination is based on dynamical scheduling, there might also be blind decoding with the eighth subframe if the UE considers full or partial subframe of PDSCH depending on whether there is PUSCH transmission behind.

In general, one solution is that if the in any of subframe is a UL subframe, the previous special subframe would be a special subframe (if the special subframe have a conflict) and the subframe(s) between the UL subframe and the special subframe would be UL subframes. As an example, if subframe 8 is a UL subframe, subframe 6 would be a special subframe and subframe 7 would be a UL subframe. Another possibility is that for the cell in which its DL subframe overlap with its UL subframe behind, only part of the subframe would be utilized for PDSCH transmission.

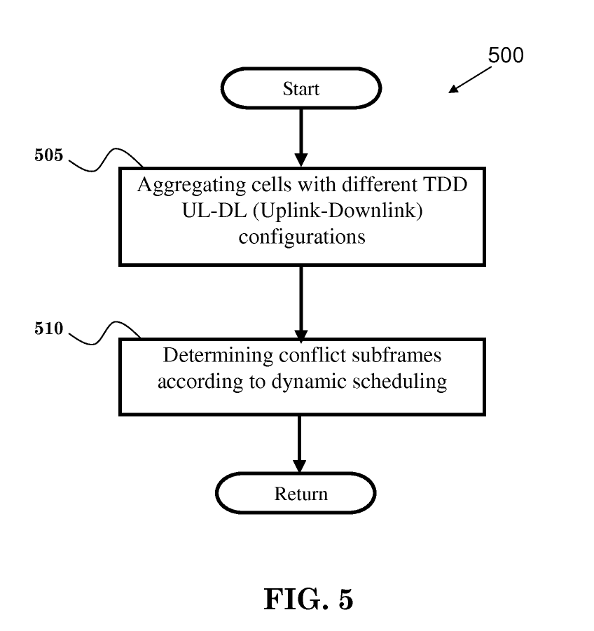

FIG. 5 illustrates a flowchart 500 in accordance with one embodiment. In step 505, cells with different TDD UL-DL (Uplink-Downlink) configurations are aggregated. In one embodiment, the cells have a same DL-to-UL (Downlink-to-Uplink) switch, point periodicity. In step 510, conflict subframes are determined according to dynamic scheduling. In one embodiment, cells that have different DL-to-UL switch point periodicities cannot be aggregated together. In addition, the cells are aggregated for a HE (User Equipment) that does not transmit and receive simultaneously.

In one embodiment, cells with different TDD UL-DL (Uplink-Downlink) configurations are aggregated. Furthermore, the cells have different. DL-to-UL (Downlink-to-Uplink) switch point periodicities. In addition, a seventh subframe is a conflict subframe and is determined as a special subframe or downlink according to a predefined rule and determining subframe type of other conflict subframes according to dynamic scheduling. In one embodiment, the predefined rule is the seventh subframe is determined as a special subframe. In an alternative embodiment, the predefined rule is the seventh subframe is determined as a downlink subframe. Also, the predefined rule could be the eNB (evolved Node B) indicates that the seventh subframe is determined as a downlink subframe or a special subframe. Furthermore, the predefined rule could be that the subframe type of the seventh subframe is the same as the subframe type of the seventh subframe of the PCell (Primary Cell).

In one embodiment, the seventh subframe is a conflict subframe and includes a PDSCH (Physical Downlink Shared Channel) for a cell with a DL subframe type and occupies only a partial subframe regardless of scheduling. Furthermore, the number of OFDM symbols occupied by the PDSCH is determined by the special subframe configuration of a specific cell, which is the cell with a smallest number of OFDM symbols for downlink (DL) in the special subframe.

Referring back to FIGS. 3 and 4, the UE 300 includes a program code 312 stored in memory 310. In one embodiment, the CPU 308 could execute the program code 312 (i) to aggregate cells with different TDD UL-DL (Uplink-Downlink) configurations, wherein the cells have different DL-to-UL (Downlink-to-Uplink) switch point periodicities, and (ii) to determine conflict subframes according to dynamic scheduling.

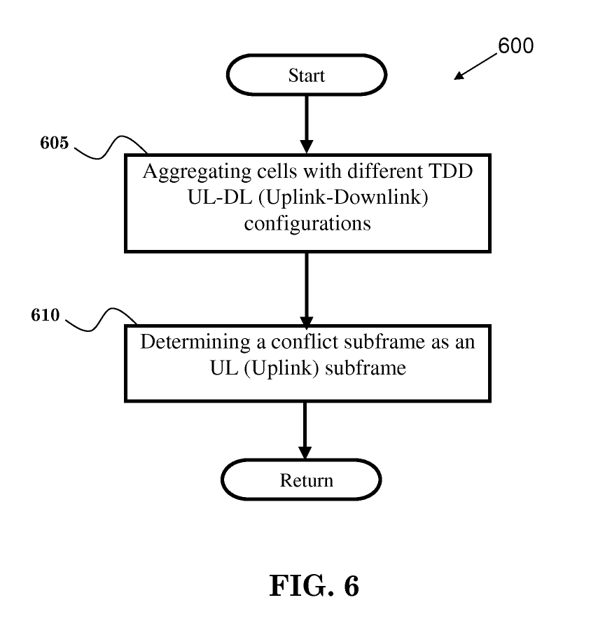

FIG. 6 illustrates a flowchart 600 in accordance with one embodiment. In step 605, cells with different TDD UL-DL (Uplink-Downlink) configurations are aggregated. In step 610, the conflict subframe is determined as an UL subframe. In one embodiment, the cells are aggregated for a UE (User Equipment) that does not transmit and receive simultaneously. Furthermore, if a special subframe preceding the UL subframe is a conflict subframe, the preceding subframe is determined as special subframe, and subframes between the preceding subframe and the UL subframe are determined as UL subframes. Also, if a subframe preceding the UL subframe is a DL subframe, the preceding DL subframe utilizes part of the subframe for PDSCH transmission. Furthermore, the number of OFDM symbols occupied by the PDSCH is determined by the special subframe configuration of a specific cell, which is the cell with a smallest number of OFDM symbols for downlink (DL) in the special subframe.

Referring back to FIGS. 3 and 4, the UE 300 includes a program code 312 stored in memory 310. In one embodiment, the CPU 308 could execute the program code 312 (i) to aggregate cells with different TDD UL-DL (Uplink-Downlink) configurations, and (ii) to determine a conflict subframe as an UL subframe.

In addition, the CPU 308 can execute the program code 312 to perform alt of the above-described actions and steps or others described herein.

Various aspects of the disclosure have been described above. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. As an example of some of the above concepts, in some aspects concurrent channels may be established based on pulse repetition frequencies. In some aspects concurrent channels may be established based on pulse position or offsets. In some aspects concurrent channels may be established based on time hopping sequences. In some aspects concurrent channels may be established based on pulse repetition frequencies, pulse positions or offsets, and time hopping sequences.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

In addition, the various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction, with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects any suitable computer-program product may comprise a computer-readable medium comprising codes relating to one or more of the aspects of the disclosure. In some aspects a computer program product may comprise packaging materials.

While the invention has been described in connection with various aspects, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

What is claimed is:

1. A method for improving TDD (Time Division Duplex) interband carrier aggregation (CA) in a wireless communication system, comprising:
aggregating cells with different TDD UL-DL (Uplink-Downlink) configurations, wherein the cells have, a same DL-to-UL (Downlink-to-Uplink) switch point periodicity; and
determining conflict subframes according to dynamic scheduling, wherein cells that have different DL-to-UL switch point periodicities cannot be aggregated together.

2. The method of claim 1, wherein the cells are aggregated for a UE (User Equipment) that does not transmit and receive simultaneously.

3. A method for improving TDD (Time Division Duplex) interband carrier aggregation (CA) in a wireless communication system, comprising:
aggregating cells with different TDD UL-DL (Uplink-Downlink) configurations,
wherein the cells have different DL-to-UL (Downlink-to-Uplink) switch point periodicities, and a seventh subframe is a conflict subframe and is determined as a special subframe or downlink according to a predefined rule and determining subframe type of other conflict subframes according to dynamic scheduling.

4. The method of claim 3, wherein the predefined rule is the seventh subframe is determined as a special subframe.

5. The method of claim 3, wherein the predefined rule is the seventh subframe is determined as a downlink subframe.

6. The method of claim 3, wherein the predefined rule is an eNB (evolved Node B) indicates that the seventh subframe is determined as a downlink subframe or a special subframe.

7. The method of claim 3, wherein the predefined rule is the subframe type of the seventh subframe is the same as the subframe type of the seventh subframe of the PCell (Primary Cell).

8. The method of claim 3, wherein the seventh subframe is a conflict subframe, and includes a PDSCH (Physical Downlink Shared Channel) for a cell with a DL subframe type and occupies only a partial subframe regardless of scheduling.

9. The method of claim 8, wherein the number of OFDM symbols occupied by the PDSCH is determined by the special subframe configuration of a specific cell.

10. The method of claim 9, wherein the specific cell is the cell with a smallest number of OFDM symbols for downlink (DL) in the special subframe.

11. The method of claim 3, wherein the cells are aggregated for a UE (User Equipment) that does not transmit and receive simultaneously.

12. A communication device for performing TDD interband carrier aggregation in a wireless communication system, the communication device comprising:
a control circuit;
a processor installed in the control circuit;
a memory installed in the control circuit and operatively coupled to the processor;
wherein the processor is configured to execute a program code stored in memory to perform TDD interband carrier aggregation by:
aggregating cells with different TDD UL-DL (Uplink-Downlink) configurations, wherein the cells have different DL-to-UL (Downlink-to-Uplink) switch point periodicities, and a seventh subframe is a conflict subframe and is determined as a special subframe or downlink according to a predefined rule; and
determining the subframe type of other conflict subframes according to dynamic scheduling.

13. The communication device of claim 12, wherein the seventh subframe is a conflict sub frame, and includes a PDSCH (Physical Downlink Shared Channel) for a cell with a DL subframe type and occupies only a partial subframe regardless of scheduling.

14. The communication device of claim 12, wherein the cells are aggregated for a UE (User Equipment) that does not transmit and receive simultaneously.

15. A method for improving TDD (Time Division Duplex) interband carrier aggregation (CA) in a wireless communication system, comprising:
aggregating cells with different TDD UL-DL (Uplink-Downlink) configurations; and
determining a conflict subframe as an UL (Uplink) subframe.

16. The method of claim 15, wherein the cells are aggregated for a UE (User Equipment) that does not, transmit and receive simultaneously.

17. The method of claim 15, wherein if a special subframe preceding the tit subframe is a conflict subframe, the preceding subframe is determined as special subframe, and subframes between the preceding subframe and the UL subframe are determined as UL subframes.

18. The method of claim 15, wherein if a subframe preceding the UL subframe is a DL subframe, the preceding DL subframe utilizes part of the subframe for PDSCH transmission.

19. The method of claim 18, wherein the number of OFDM symbols occupied by the PDSCH is determined by the special subframe configuration of a specific cell.

20. The method of claim 19, wherein the specific cell is the cell with a smallest number of OFDM symbols for downlink (DL) in the special subframe.

21. A communication device for performing TDD interband carrier aggregation in a wireless communication system, the communication device comprising:
a control circuit;
a processor installed in the control circuit;
a memory installed in the control circuit and operatively coupled to the processor;
wherein the processor is configured to execute a program code stored in memory to perform TDD interband carrier aggregation by:
aggregating cells with different IUD UL-DL (Uplink-Downlink) configurations; and
determining a conflict subframe as an UL (Uplink) subframe.

22. The communication device of claim 21, wherein if a special subframe preceding the UL subframe is a conflict subframe, the preceding subframe is determined as special subframe, and subframes between the preceding subframe and the UL subframe are determined as UL subframes.

23. The communication device of claim 21, wherein if a subframe preceding the UL subframe is a DL subframe, the preceding DL subframe utilizes part of the subframe for PDSCH transmission.
